(19) United States
(12) Patent Application Publication
(10) Pub. No.: US 2026/0019015 A1
(43) Pub. Date: Jan. 15, 2026

(54) SYSTEM AND METHOD FOR GENERATING POWER USING A VARIABLE SPEED GENERATOR

(71) Applicant: The Estate of Michael W. Brochu, Lighthouse Point, FL (US)

(72) Inventors: Michael W. Brochu, Lighthouse Point, FL (US); Daniel T O'Donnel, North Miami Beach, FL (US)

(21) Appl. No.: 19/266,935

(22) Filed: Jul. 11, 2025

Related U.S. Application Data
(60) Provisional application No. 63/670,030, filed on Jul. 11, 2024.

(51) Int. Cl. H02P 9/02; H02J 5/00

(52) U.S. Cl. CPC H02P 9/02; H02J 5/00

(57) ABSTRACT

A system for generating power using a variable speed generator is disclosed. The system comprises an engine configured to operate at variable RPMs and an axial flux oriented generator comprising a rotor assembly with a circular plate and alternating polarity magnets, and a stator assembly with triangular-shaped coils connected to achieve desired output voltages and power levels. Output terminals are connected to a rectifier for converting AC to DC power. A processor receives load requirements and maintains a constant set output frequency independent of engine RPM, adjusts generator speed accordingly, and produces multiple output channels with Voltage Buffers to accommodate load spikes. A user interface allows software-based selection of AC or DC output, single or three-phase, and different frequencies without physical reconfiguration. Connectivity elements using CAN-Bus architecture enable integration and monitoring. An electronics package with PWM and IGBT modules modulates voltage output to maintain performance despite load fluctuations.

### REFERENCE TO RELATED APPLICATIONS

This application is a non-provisional application which claims the benefit of the filing date of U.S. Provisional Application Ser. No. 63/670,030 titled “System and Method for Generating Power Using a Variable Speed Generator” and filed Jul. 11, 2024 and the subject matter of which is incorporated herein by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of variable speed generator system, and more specifically to the field of generating power using a variable speed generator system.

### BACKGROUND OF THE INVENTION

A variable speed generator system refers to a power generating mechanism that can adjust its rotational speed to match the load requirements, thereby optimizing energy production and improving efficiency. Generally, in power generation, the term variable speed indicates the capability of the generator to operate at different speeds based on the demand or the input energy source, as opposed to a fixed speed generator that operates at a constant speed regardless of the load or input conditions.

Specifically, a variable speed generator system adjusts its rotational speed in response to varying load demands or fluctuating input energy (like wind speed in wind turbines or water flow in hydroelectric systems). This adaptability allows for a more efficient conversion of mechanical energy into electrical energy, as the generator can operate at optimal speeds that match the energy input, reducing energy wastage and enhancing the overall system efficiency.

Generators with a radial flux design are the conventional type, where the magnetism is parallel to the rotating axis and the coils are constructed with an iron core laminations. In these generators, the stator, which holds the coils, is typically arranged in a circle around the rotor, which is fitted with magnets or electromagnets.

The radial flux design faces several challenges and limitations. One significant issue is the size and weight of these generators, especially in higher power applications, as they require a large amount of magnetic material and copper, making them bulky and heavy. This can be a major drawback in applications where space is limited or where weight is a critical factor, such as in automotive, standby, marine, or aerospace applications. Additionally, the efficiency of radial flux generators can be lower, especially at partial loads, due to the inherent design characteristics that can lead to higher core losses and less optimal utilization of the magnetic field. The air gap between the rotor and stator is also a critical factor; maintaining the optimal gap is crucial for efficiency but can be challenging, especially in larger designs where mechanical stresses and thermal expansion come into play.

Traditional generators operate at a constant speed to maintain the standard frequency of the electricity they produce, typically 50 or 60 Hz, regardless of the actual load because the frequency is based on the engine rpms. This fixed-speed operation leads to substantial fuel wastage, especially under partial load conditions, as the generator consumes fuel even when demand is low. Such inefficiency not only results in higher operational costs but also contributes to excessive wear on the engine, shortening its lifespan and increasing maintenance needs. These generators emit large amounts of exhaust gases due to their constant high-speed operation, exacerbating environmental pollution. Their bulky design demands significant space, which is particularly disadvantageous in urban or space-constrained settings. This combination of factors renders traditional generators inefficient, costly to operate, and environmentally unfriendly, highlighting the need for more adaptable and efficient power generation solutions.

The configuration, design, and connectivity of the coils within a generator are pivotal in determining the output voltages and the number of phases the generator can produce. Typically, generators are equipped with a terminal block that facilitates the arrangement of between four to twenty-four different leads, allowing for a variety of connection configurations. In the context of a standard US 60 Hz generator, options often include selecting between 120 v, 120/240 v, 240/480 v, and whether the output should be single or three-phase. A three-phase output is contingent upon the generator being specifically designed for such a capability. Opting to configure a three-phase designed generator to operate in single-phase mode can result in a reduction of approximately 35% of the generator's total output capacity. Consequently, the voltage generated by a generator is fundamentally a result of the interaction between the length of the wire coils in the stator and the magnetic field induced by the rotor, which spins at a predetermined speed within the stator.

As a result, there exists a need for improvements over the prior art and more particularly for a more efficient way of generating power using a variable speed generator system.

### BRIEF SUMMARY OF THE INVENTION

A system and method for generating power using a variable speed generator is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for generating power using a variable speed generator is disclosed. The system comprises an engine, an axial flux oriented generator, a processor, a receiving element, a user interface, and a plurality of connectivity elements. The engine is configured to operate within a range of a plurality of engine outputs and each of the engine outputs comprises a constant set output frequency (i.e., 60 Hz), and a variable output revolutions per minute (“RPM”). The axial flux oriented generator is connected to the engine and comprises a rotor assembly with a circular plate comprising a plurality of magnets. The plurality of magnets are configured with alternating north and south polarity and a stator assembly comprised of a plurality triangular-shaped coils connected to achieve desired output voltages and power levels The stator assembly has output terminals from the plurality triangular-shaped coils are connected to a terminal block and subsequently through a rectifier to convert AC signal into DC power. The processor is configured to send and receive signals to, from, and between the engine and a load attached to the variable speed generator system, and the receiving element is in communication with the processor for receiving load requirements of the load electrically connected to the variable speed generator system. The user interface allows for selection between AC or DC voltage outputs, single or three-phase outputs, and different frequencies, all selections programmable via software without the need for physical reconfiguration of the generator.

The plurality of connectivity elements for data transmission to external systems or devices via a CAN-Bus architecture (e.g., N2K), facilitates system integration and monitoring. The processor has instructions configured for maintaining a constant set output frequency of the generator independent of the variable output RPMs, determining the load requirement of the load electrically connected to the variable speed generator, and adjusting a speed of the generator to produce the load requirements for the load while maintaining the constant set output frequency. Further, the processor is configured to produce a plurality of output channels, each output channel configured to provide one of a multiple of output voltages (single-phase or three-phase, AC and/or DC), including an operational “Voltage Buffer” to accommodate load spikes. The processor is configured such that each output channel comprises an operational “Voltage Buffer” over a required output voltage to handle any load spikes in the load requirements.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a is a block diagram illustrating a system for generating power using a variable speed generator, according to an example embodiment;

FIG. 2A is an exploded perspective view of portions of an axial flux generator, according to an example embodiment;

FIG. 2B is a top view of portions of the stator assembly, namely the triangular shaped coils and the resin plate, of the axial flux generator, according to an example embodiment;

FIG. 2C is an exploded schematic view of a generator, according to an example embodiment;

FIG. 2D illustrates a exploded schematic view of a magnet plate assembly, according to an example embodiment;

FIG. 2E illustrates a front view of the coil of a stator assembly, according to an example embodiment;

FIG. 2F is a front schematic view of the magnet plate of a generator, according to an example embodiment;

FIG. 2G is a schematic view of a power output module of a system, according to an example embodiment;

FIG. 2H is a DC output graph of both positive and negative portions, according to an example embodiment;

FIG. 2I is a graph illustrating a typical alternating current (AC) sine wave, having a frequency, of 50 or 60 hertz (Hz);

FIG. 2J is a graph illustrating a sine wave overlaying the raw DC output. This is used to envision the 200 PWM channels from the processor to create the AC sinewave, according to an example embodiment

FIG. 3 is a side sectional view of an System for power generation, according to an example embodiment;

FIGS. 4A and 4B are example graphical user interfaces displayed on a computing device, in accordance with an example embodiment;

FIG. 5A is a flow chart illustrating a method for converting DC stator output into AC sine wave output at a set frequency, according to an example embodiment;

FIG. 5B is a flow chart illustrating a method for establishing an upper limit for a “Voltage Buffer” or a buffer voltage, according to an example embodiment;

FIG. 5C is a flow chart depicting a method for adjusting generator speed, according to an example embodiment;

FIGS. 5D and 5E illustrate flowcharts of a method for adjusting parameters of a system based on load on the system, according to an example embodiment;

FIG. 6 is a block diagram of a system including an example computing device and other computing devices, according to an example embodiment.

Like reference numerals refer to like parts throughout the various views of the drawings. The figures are drawn to scale.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting, reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the prior art by providing axial flux generators that are more efficient than radial flux designs because they follow a more direct magnetic path, which reduces energy losses. This efficiency is due to their perpendicular arrangement of magnetism relative to the rotating axis, allowing for a more compact and effective electromagnetic interaction. In contrast, radial flux designs have magnetism parallel to the axis and utilize iron core laminations, which can introduce higher magnetic losses and inefficiencies. The disclosed embodiments improve upon the prior art by producing fewer emissions and has a smaller carbon footprint by optimizing power output to match demand precisely. This approach minimizes unnecessary engine operation, leading to lower fuel consumption, reduced emissions, and less engine wear, thereby enhancing environmental sustainability and extending the lifespan of the generator system. The disclosed system utilizing a variable speed generator offers enhanced control over several operational parameters, such as the type of voltage output (AC or DC) and the choice between single-phase or three-phase output. Further, the disclosed embodiment improve over the prior art by incorporating connectivity elements for data transmission via a CAN-Bus architecture, such as NMEA 2000 (N2K). Such connectivity elements allow for real-time data exchange, streamlined diagnostics, and efficient coordination between different system components, significantly improving operational reliability and performance optimization. Additionally, the system improves over the prior art by providing software and electronics in a variable speed generator system to allow precise control of operating parameters, including frequency, AC, and DC output. The software and electronics integration results in enhanced efficiency, adaptability to varying power demands, and improved stability in power generation, optimizing performance and energy output. This flexibility in control contributes to improved overall performance and utility of the system, accommodating a wide range of applications and load conditions.

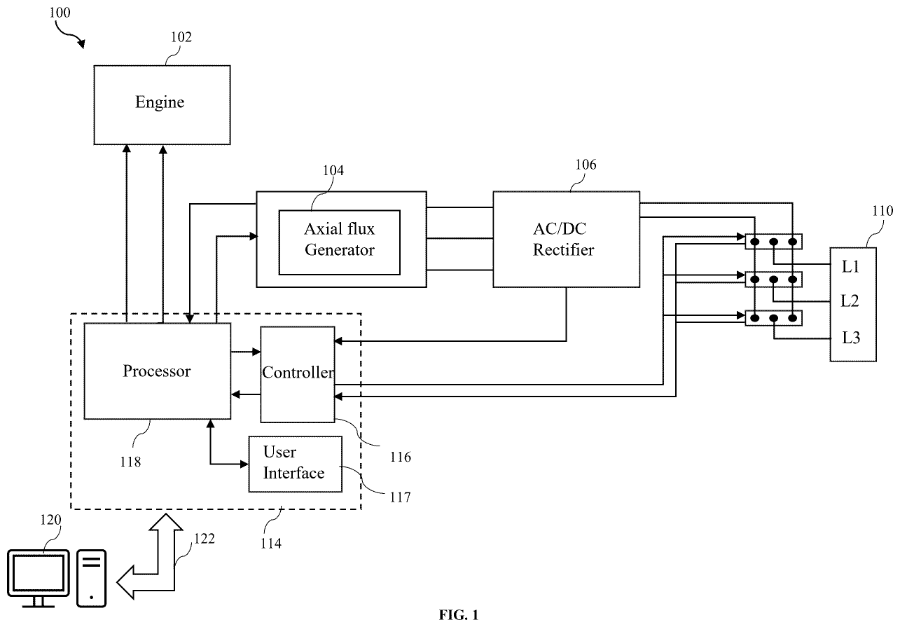

Referring to FIG. 1, a system 100 for generating power using a variable speed generator system is depicted in accordance with an embodiment. The system 100 is an assembly comprising several components, an engine 102, an axial flux oriented generator 104, an AC/DC rectifier 106, a voltage controller (not shown in the figure), and a load 110. The system further comprises a processor 118, a receiving element, a user interface 117, and a multitude of connectivity elements 122 for data transmission to external system 120.

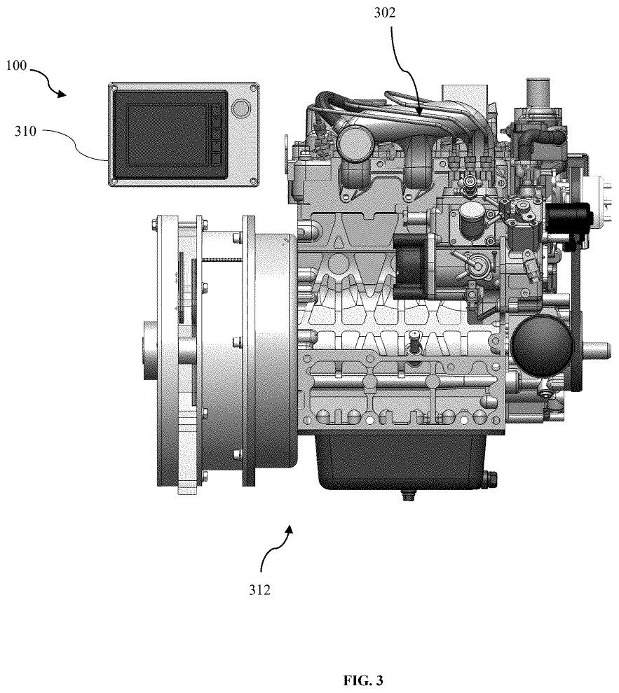

The engine's speed is variable, while the processor maintains a constant frequency regardless of the engine rpms. This flexibility allows the engine to adjust its performance based on the load demand, optimizing fuel efficiency and operational efficiency. As shown in FIG. 3, the system 100 has an engine 302, a generator 312, and a user interface 310. The engine depicted serves as the primary power source for the generator, responsible for converting fuel into mechanical energy, which is then transformed into electrical energy by the generator.

In this example, the described engine 102, as shown in FIG. 3, is designed to deliver its peak power over 2600 revolutions per minute (RPM). The engine is configured to operate within a range of a plurality of engine outputs. Traditionally, achieving higher power necessitates using a larger engine. The disclosed engine has a compact size while enabling the generator to produce 120/240 volts at approximately 700 RPM. The integrated electronics regulate the output frequency consistently at 60 hertz. As the load increases, the “Voltage Buffer” takes over then the engine dynamically adjusts its speed to manage the additional demand, optimizing its use beyond the conventional limit of 1800 RPM. This approach ensures efficient utilization of the engine's capabilities without the need for upsizing.

In a comparative example, a 4 pole 21 KW Onan generator operating at 1800 rpms is used to maintain 60 hz. Traditionally generators use a voltage regulator to control the outputted voltage. This generator is typically set up to be operating at 61-62 Hz and 120-125 volts at no load. A DC voltage of about 4 volts is introduced into the excitor stator. When a load is introduced and current is demanded from the output, the voltage drops a little and the generator bogs down a little, at that point the voltage regulator increases the DC voltage to the excitor stator to bring the voltage back to 120 volts. They use much larger engines to have enough power so that the load on the engine is a minimum. In an example embodiment, a 2.4-liter 4-cylinder diesel engine that makes 28 HP at 1800 rpms is used. If a smaller engine is used, the time that the engine needs to correct for the loss in rpm's becomes just one of its obstacles to overcome.

In traditional systems, engine rpms is directly correlated to the frequency of the electricity generated. Most engines are equipped with a governor or an electronic control unit (ECU) that regulates the engine's speed in response to varying loads. By adjusting factors such as fuel injection rate and air intake, the engine's speed is maintained at a level that ensures the generator produces electricity at the correct frequency and voltage. This regulation is crucial for the stability and reliability of the power output, ensuring that the generator can respond effectively to varying power demands.

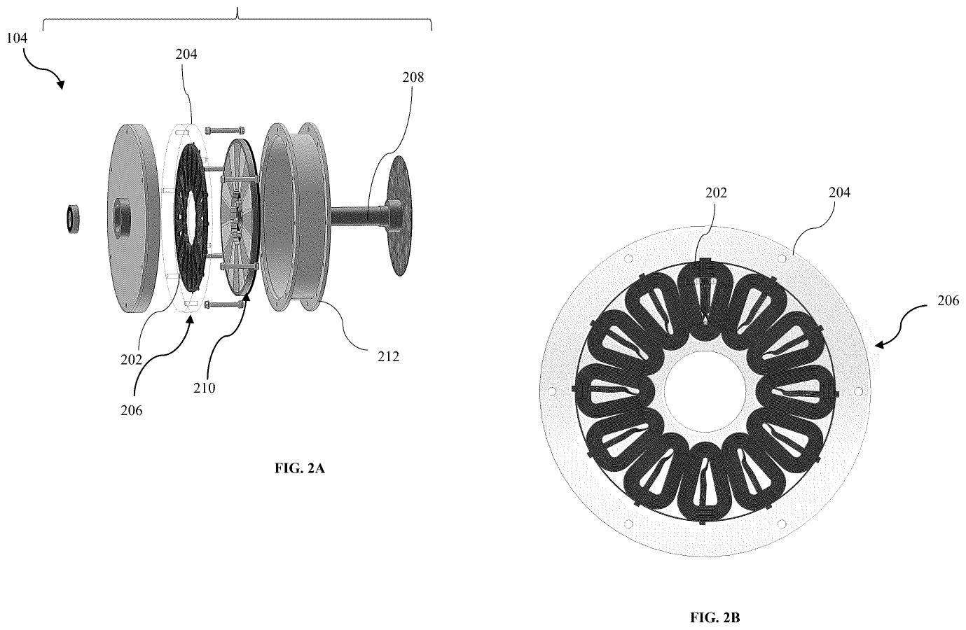

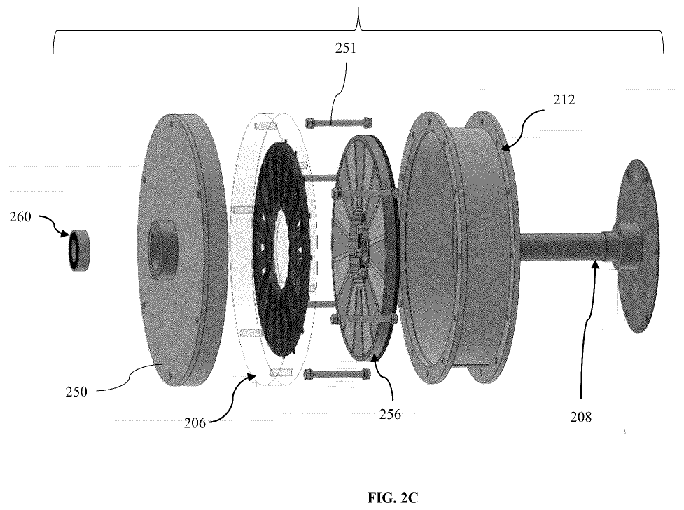

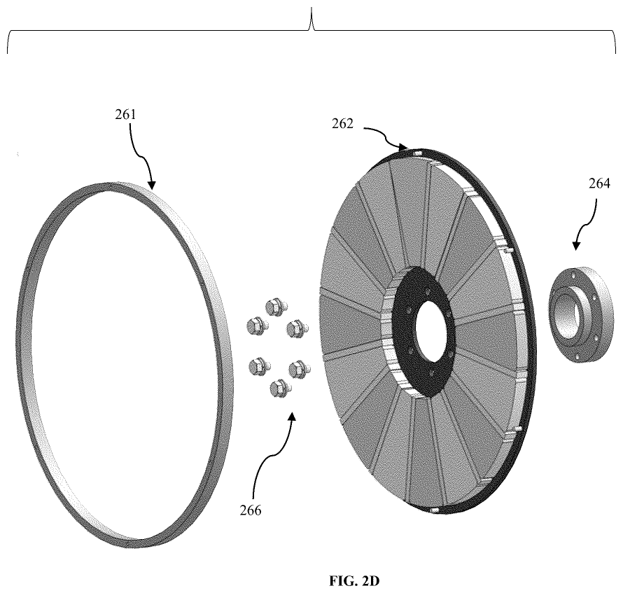

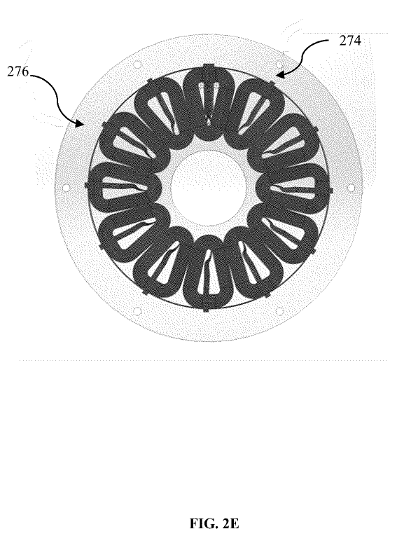

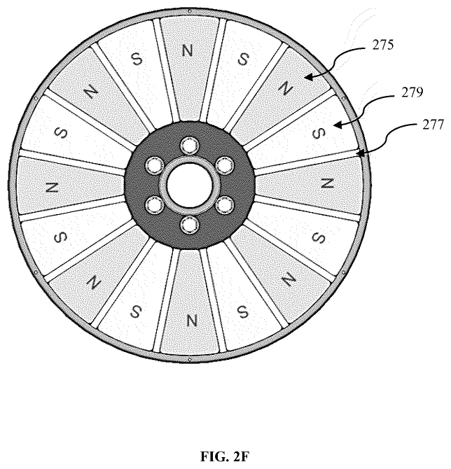

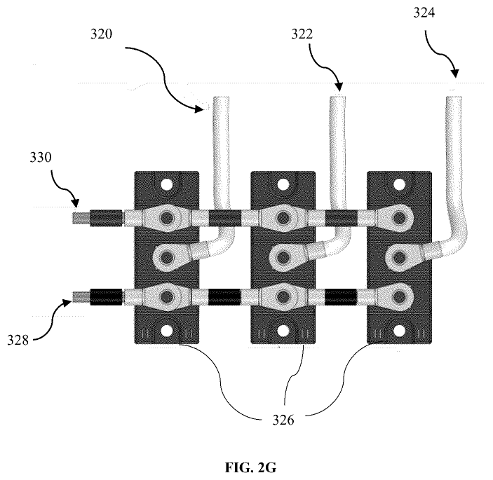

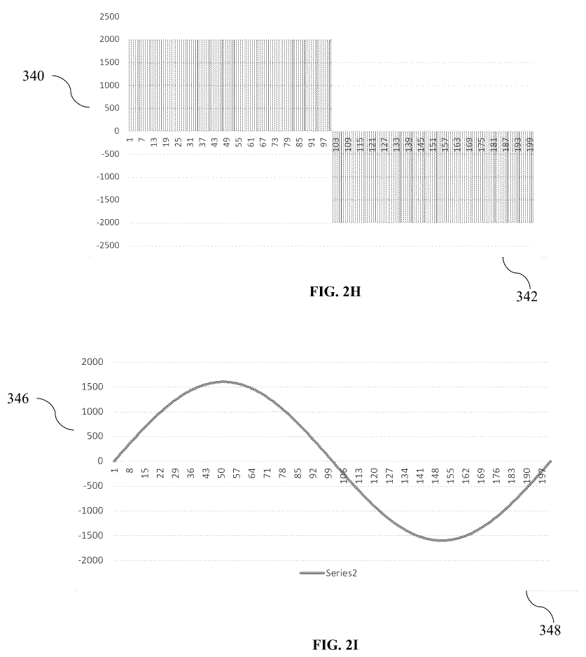

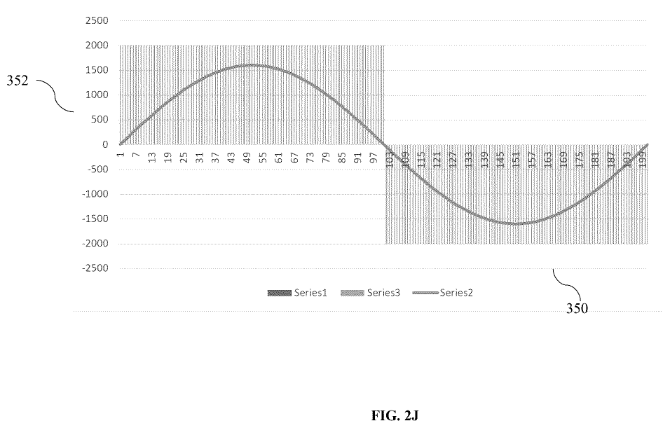

In this design, the output of the engine is coupled to the axial flux oriented generator 104 of FIG. 2A. The engine is configured to operate within a range of a plurality of engine outputs. The engine is mechanically coupled to the generator through a shaft or direct coupling, which allows the rotational energy produced by the engine to be converted into electrical energy by the generator. This setup is crucial for the seamless transfer of energy, where the engine's mechanical output is directly responsible for driving the generator, which in turn, generates electricity. The design ensures that the energy produced by the engine is efficiently utilized, with minimal loss, to produce reliable electrical power.

Referring to FIGS. 2A and 2B, the axial flux oriented generator 104 has triangular-shaped coils 202 that form the stator of the axial flux oriented generator, a shaft 208, a housing 212, and a stator assembly 206 having a circular plate 204 that comprises resin. A rotor assembly of the axial flux generator has a circular plate 210 embedded with a series of triangular shaped magnets arranged in alternating north and south polarities for generating a magnetic field, as shown in FIGS. 2A, and 2C. The generator's stator assembly has triangular-shaped coils 202 connected to achieve the required output voltages and power levels, as shown in FIGS. 2A, 2B and 2C. These coils are designed for optimal energy induction from the rotating magnetic field.

The stator is attached to the frame for stability, interacts with a rotor assembly having the circular plate with magnets arranged in alternating north and south polarities. As the shaft rotates, it induces electromagnetic forces in the triangular coils, producing electricity. The unique triangular coil design enhances the efficiency of magnetic flux interactions, optimizing the generator's electrical output and operational efficiency.

It is understood that in other embodiment, more than one plate and or coils, depending on application and requirements, may be used and are within the spirit and scope of the present invention. In the axial flux generator, the rotors are positioned on either side of the stator or sandwiching it, depending on the design (single or dual rotor configurations). The stator, which contains the electrical windings, remains stationary. The rotors, equipped with magnets, move to create a rotating magnetic field. This movement induces an electrical current in the coils of the stator. One of the unique features of this generator is its coil arrangement. The coils are typically shaped like triangles or other geometries that conform to the generator's design, optimizing the space and enhancing the efficiency of magnetic flux. As shown, the stator has multiple coil sets. These coils' arrangement, design, and connections are crucial in defining the generator's voltage outputs and phase count. Typically, generators are equipped with a terminal block, allowing for the configuration of 4 to 24 leads to establish various connections. In standard 60 Hz generators, options often include 120 v, 120/240 v, 240/480 v, along with single or three-phase selections. The terminal block allows for various connections in generators that utilize these terminal blocks. The rotor assembly is designed with a circular plate equipped with specially made magnets arranged in a pattern where north and south poles alternate. It can have a single plate with magnets on one side or be adapted to include a magnetic plate on both sides, depending on the required power output in kilowatts (KW). This design can also easily incorporate an additional stator assembly, double the power output while increasing the length by only about 2 inches. In an embodiment, the stator assembly is modular, allowing assembly in one, two, or three sections depending on the desired output, and includes output terminals connected to a rectifier for converting AC signal into DC power.

The stator assembly consists of many triangular coils arranged in various ways to match the needed power output. The triangular-shaped coils are arranged in a way that maximizes the exposure to the magnetic field created by the spinning rotors. Another unique feature of this generator is that this arrangement allows for a more compact generator design, reducing the overall size and weight while maintaining high power output. The close proximity of the coils to the magnetic field results in efficient electricity generation, as it minimizes energy loss that typically occurs in traditional designs due to the longer distance the magnetic flux travels. The thickness of the wires in these coils varies based on the required kilowatts and voltage. This setup can work with voltages from 40 to over 800 volts. Depending on the output required, the stator is put together in one, two, or three sections. Various configurations, including one with a single coil, one with two coils, and one with two coils plus a cooling ring may be used.

The unique aspect of this design is the axial alignment of the rotor and stator, as they are positioned parallel to each other, facilitating a compact and efficient structure conducive to generating electrical power.

Specifically, the stator of an axial flux generator is equipped with coils that are distinctively triangular, wound around the stator's circumference. It is understood that although the coils are illustrated as triangular in shape, different shapes and sizes of the coils, other than the triangular shape, are covered within the scope of the invention.

The operation of the axial flux generator begins with mechanical energy input from the engine, which drives the rotation of the rotor. As the rotor spins, its magnets move in close proximity to the stator's coils, inducing a current through electromagnetic induction. This process converts the mechanical energy from the engine into electrical energy, which can then be used to power various loads or stored for later use. This process is integral to the generator's functionality, transforming kinetic energy into usable electrical energy. The system's overall efficacy is significantly influenced by the precise arrangement of the rotor and stator, with the circular, coaxial design minimizing energy losses and enhancing power output.

Axial flux motors, using a combination of high-powered rare-earth magnets, are considered superior to conventional motors in several ways. Their design allows for a more compact and lightweight unit, in many cases less than 20% of the size of a conventional motor, providing a higher power density that is beneficial in applications where space and weight are critical factors. They are also known for their efficiency, as the direct path of the magnetic flux reduces energy losses, making them particularly effective for renewable energy systems like wind turbines or in electric vehicles. In axial flux motors, the magnetism is perpendicular to the axis and generally having an air or resin core. The rotating mass is greatly reduced in the axial flux design. This compact design also allows for increased magnetic interaction by gaining the ability to have the magnets placed on both sides of the coils. The greater availability of high power magnets provides improved density of the magnetism. Overall, the axial flux motors offers advancements in motors technology that address the limitations of traditional designs, making it a valuable option for modern energy solutions. In this embodiment, as shown in the figure, the system utilizes a single coil and a single plate. Alternative embodiments may incorporate multiple plates and coils, depending on specific application needs and operational requirements. These variations are designed to adapt the fundamental technology to different contexts and enhance functionality or performance, reflecting the versatile nature of the invention. All such configurations, whether they involve additional plates, multiple coils, or a combination of both, fall within the spirit and scope of the present invention, offering broad applicability and potential customization according to the application.

In the detailed schematic of FIG. 2C, the axial flux oriented generator, integral to the system, is shown. The end cap 250 covers the assembly on one side, anchoring the structural framework, while the mounting housing 212 envelopes the generator, serving as a sturdy chassis that facilitates attachment to other system parts. The shaft 208 forms the central axis and is integral for transferring mechanical motion, around which the magnet plate 256 is centered, designed to rotate and create a varying magnetic field. The stator assembly 206, typically static, is placed surrounding the magnet plate, and is where the conversion of mechanical energy to electrical energy occurs. Lastly, the bearing 260, nestled typically between the shaft and end cap, allows for a low-friction pivot, ensuring smooth operation.

In this example, the system maintains a constant set output frequency of the generator independent of the variable RPMs.

The advantages of incorporating such a generator into a system are manifold. Its sophisticated design and material choice result in high efficiency and reliability, translating into a system that demands less maintenance and exhibits a longer operational life. Furthermore, the precision control afforded by the system's processor and controller allows for the tailoring of output to specific needs, which is a considerable improvement over less flexible and efficient predecessors. This generator stands as a testament to modern engineering's capability to optimize energy conversion while providing adaptability and resilience, significantly surpassing the performance parameters of previous generation technologies. Further, The system is tailored to optimize the electromagnetic interaction for a predefined generator size and output capacity, including but not limited to 20 kW of output at 124/240 volts for both single and three-phase connections.

FIG. 2D depicts the magnet plate assembly, a fundamental component within the generator, by presenting an exploded view which reveals the intricate interrelationship between its constituent parts. The retaining ring 261, encircles the outer perimeter, serving as a securing device that maintains the position of other components within the magnet plate. The backing plate 262, lies immediately adjacent to the retaining ring and provides a robust surface upon which the magnetic elements can be mounted. At the core of the assembly, the shaft hub 264, is the central fixture designed to attach to the generator's shaft, allowing for the transfer of mechanical motion. The nuts 266, are the fastening elements that secure the backing plate to the shaft hub, ensuring the integrity of the assembly when in motion.

Material selection for the magnet plate assembly components is pivotal for the functionality and durability of the generator. The retaining ring 261, which must withstand the stresses of rotation, is commonly crafted from high-strength steel or a similar durable alloy. The backing plate 262 is also constructed from a robust metal such as steel, which offers a stable platform for the magnetic elements and supports the structural load. The shaft hub 264 is typically made from hardened steel or another material with a high modulus of elasticity to endure the torque applied during operation. Lastly, the nuts 266 are often made of a hardened metal, such as stainless steel, chosen for their ability to secure tightly without loosening under vibration or stress.

In the broader context of the generator system, the magnet plate plays a pivotal role. As part of the rotor assembly, it interacts with the stator to convert mechanical energy into electrical energy via electromagnetic induction. The retaining ring 261 ensures that the magnetic elements are held firmly in place, the backing plate 262 provides a secure mounting point, and the shaft hub 264 translates rotational energy from the shaft to the magnet plate. This structure is instrumental in creating a stable, uniform magnetic field, which is essential for efficient power generation. The advantage of such a magnet plate design in the generator is that it ensures a consistent and powerful magnetic flux, which directly correlates to higher efficiency and reliability in power generation. Furthermore, it allows for more compact generator designs, which can be beneficial in applications where space is at a premium.

FIG. 2E presents a front view of the coil set 274 of the generator's stator, detailing the integration of the resin mold 276, which encapsulates the coil. The resin mold is meticulously disposed around the inner coil, contouring its shape and filling the interstitial spaces, providing several benefits to the stator's structure and function. This mold serves to secure the coil in place, mitigating vibrations and potential damage from operational stresses. Furthermore, the resin, by its very nature, is an excellent insulator, enhancing the coil's thermal properties by improving heat dissipation and also protecting the windings from environmental factors like moisture or chemical corrosion, which can extend the life of the stator and maintain its performance over time.

The inner coil set 274 is an integral component of the stator, typically placed concentrically within the stator assembly. It operates in conjunction with the outer coil set, if present, to induce electrical currents when exposed to a magnetic field. The placement of the resin mold 276 around the inner coil ensures that the coil maintains its precise geometric configuration, which is essential for its efficient functioning. The resin's rigidity also prevents the deformation of the coils during operation or in the event of thermal expansion, thus maintaining the integrity of the magnetic path and the consistency of the electrical properties of the stator.

In the context of the stator assembly, the coil set 274 is positioned in such a way that, when assembled, it aligns with the magnetic flux path generated by the rotor's motion. The embedding of the inner coil within the resin mold 276 allows for a unified, solid structure that can be easily integrated with other stator components. The resin mold's role is not only structural but also contributes to the electrical insulation and thermal management of the stator. The inclusion of such a resin mold is advantageous as it provides a durable, low-maintenance, and high-performance solution, essential for the reliability and longevity of generators, especially in demanding operational environments.

FIG. 2F presents a front schematic view of the magnet plate within a generator, illustrating a strategic arrangement of magnets to optimize electromagnetic performance. The figure showcases an alternating pattern of north-facing magnets 275, labeled as ‘N’, and south-facing magnets 279, labeled as ‘S’. Positioned between each pair of these oppositely polarized magnets are magnet inserts 277, which serve to enhance the magnetic field interactions. This alternate arrangement of magnets of opposite polarity is critical as it promotes a more uniform magnetic field across the plate, which in turn, can significantly increase the efficiency of the electromagnetic induction process essential for power generation. The inclusion of magnet inserts between the north and south poles facing magnets serves a dual purpose: it not only stabilizes the structural integrity of the magnet plate, preventing the magnetic fields from canceling each other out, but also amplifies the magnetic flux density. This configuration markedly improves the generator's output by ensuring a continuous and enhanced generation of electromagnetic force compared to conventional designs lacking such an optimized arrangement.

The power output modules depicted in FIG. 2G serves as a crucial element within the system, functioning as a sophisticated electrical apparatus designed to manage and distribute direct current (DC) power to various outputs. This module is tasked with the conversion and conditioning of electrical power, ensuring the proper functioning of the system by delivering stabilized DC voltage to multiple outputs. These components are methodically arrayed to form a coherent unit: Output 320 L1, Output 322 L2, and Output 324 L3, are aligned vertically, acting as conduits for the electricity converted and regulated by the MOSFET Modules 326. Inputted DC sources 328 and 330 are positioned at the entry point of the modules, signifying their role as the primary sources of DC power to be processed.

In operation, the MOSFET Modules 326 play a pivotal role, acting as switches for the electronic outputs, controlling the flow of power. These modules are strategically interspersed among the outputs to ensure an efficient distribution of power. The physical arrangement of the components ensures minimal power loss and optimized electrical flow, with the Inputted DC sources 328 and 330 feeding the module, and the MOSFET Modules 326 regulating the power before it is channeled to the respective outputs. This configuration not only provides the benefit of a streamlined power distribution but also enhances the overall reliability and efficiency of the system. The modular design of the power output module allows for scalability and ease of maintenance, representing a significant advancement over prior art by reducing complexity and improving the power handling capabilities of the system.

Referring to FIG. 1, the power generated from the generator is initially in AC form, which is then routed through a AC/DC rectifier 106, transforming the AC output into DC power, suitable for a wide range of applications. The AC/DC rectifier converts alternating current (AC) into direct current (DC). The DC output is then provided to the MOSFET modules. The outputted channels from the processor provide Pulse Width Modulation (PWM) signals that are sent to the MOSFET Module 326 which then takes the DC input voltage from the sources 328 and 330 and generate the designated voltages at the designated frequency.

Referring to FIG. 2H, the DC output graph illustrates the relationship between the pulse height DC voltage and the stator output in the generator. On the Y-axis 340, the pulse height DC voltage represents the potential voltage coming out of the stator as plotted on x-axis 342. Assuming that the value of 2000 is actually 200 volts, this indicates the maximum voltage potential that the generator can output at its current revolutions per minute (RPM). The graph provides a visual representation of the voltage output capacity of the generator, which is critical for understanding the performance limitations and capabilities of the system. The AC sinewave chart of FIG. 2I depicts a typical alternating current (AC) sine wave, where the frequency, such as 50 or 60 hertz (Hz), indicates the number of complete sine wave cycles that occur in one second. On the Y-axis 346, the pulse height is displayed, while the X-axis 348 is divided into 200 segments. The first 100 segments represent the positive portion of the sine wave, and the second 100 segments represent the negative portion. This positive and negative output is applied to each of the MOSFET modules 326. These modules play a crucial role in shaping the AC output waveform and ensuring the desired frequency and voltage characteristics. Traditionally, transistors operated as simple on/off switches, with the duty cycle adjusted to yield a lower output. Modern advancements have introduced very high switching speeds in IGBT MOSFET transistors, allowing them to turn on and off more than 30,000 times per second. The peak output voltage passing through the transistor determines the time it takes to reach full potential, which is a key factor in Pulse Width Modulation (PWM) construction. For instance, when a user selects a desired voltage, such as 120 volts at 60 Hz, the AC voltage is measured in root mean square (RMS) rather than peak voltage. Therefore, a 120 VAC RMS translates to a peak voltage of approximately 170 volts (120/0.707).

The overlay graph of FIG. 2J demonstrates the process of generating the sine wave using pulses from the processor. The graph illustrating the y-axis 352 and the x-axis 350. These pulses are transferred to the IGBT MOSFETs, where the pulsing of the DC voltage through the MOSFETs generates the sine wave. The DC output at maximum RPM is 200 volts, while the sine wave output is 120 VAC with a peak of around 170 DC volts. The “Voltage Buffer” would be the voltage above the selected 120 VAC (170 VDC), approximately 30 volts in this example, and it represents the excess current capacity through the coils. The processor measures the outgoing voltage to ensure it matches the selected voltage. When a load is applied to the generator, the voltage decreases slightly, depending on the load size, such as a light bulb, oven, or air conditioning unit. The feedback mechanism adjusts the sine wave channels to maintain the designated 120 VAC, compensating for load changes instantaneously due to the high switching speed of the MOSFETs utilizing the “Voltage Buffer”. Certain loads, like air conditioning units, are sensitive to voltage, current draw, and frequency variations. For instance, air conditioning compressors will shut down if the frequency drops below approximately 58 Hz or if there is a voltage deviation greater than 10%. Processing the loads and adjusting the engine RPM has to be very precise and that is very difficult to do in the time frame of 2 or 3 seconds before the A/C system shuts down. This is only one of the main reasons that previously executed variable generators have failed in the marketplace. These spikes in current draw are all handled in “Voltage Buffer” which is adjusted instantaneously in the disclosed embodiments. The processor then increases the engine's RPM to “refill” the “Voltage Buffer”. This precision in processing loads and adjusting engine RPM ensures seamless operation and unnoticeable load changes, maintaining stability and reliability in the generator's output.

The processor 118, which orchestrates the operation by communicating with the engine and the connected load. The processor adjusts the engine's parameters to suit the immediate power requirements, ensuring efficient operation. The processor is connected to a receiving element that gathers data on the load's requirements, ensuring the generator meets these demands efficiently. The system also has a user-friendly interface that allows operators to choose the type of voltage (AC or DC), the phase output (single or three-phase), and the frequency. These settings are easily configured through software, eliminating the need to manually reconfigure the generator's hardware. This software-enabled flexibility allows for quick adaptations to different power needs.

The processor is programmed to keep the generator's output frequency stable, regardless of fluctuations in revolutions per minute (RPM), and adjusts the generator's speed to meet the exact power requirements of the load while ensuring the frequency remains constant. This capability is vital for applications that demand consistent power quality, regardless of variations in load or operational speed. Additionally, the processor manage multiple output channels, each tailored to supply a specific voltage level. These channels can accommodate various power needs, whether for single-phase or three-phase, AC or DC output. In an example, each channel includes a built-in “Voltage Buffer”, ensuring there is extra capacity to handle sudden increases in power demand during load spikes without compromising the system's stability or performance. Such spikes might occur during sudden increases in power demand or transient faults in the electrical system. This feature is especially crucial for maintaining uninterrupted service and protecting both the generator and the connected equipment from potential damage due to unexpected power surges.

The “Voltage Buffer” is specifically designed to accommodate unexpected load spikes. By including this “Voltage Buffer”, the processor ensures that the generator can handle these spikes without compromising the stability or safety of the power supply. This built-in buffer not only safeguards the generator and connected devices from potential overloads but also contributes to the longevity of the system by preventing the excessive strain that can occur during load spikes. Furthermore, the processor's ability to manage multiple output channels with such precision and flexibility allows for a tailored power supply, catering to the specific needs of each connected load while ensuring efficiency and reliability. Such features make the generator system exceptionally suited for a wide range of industrial, commercial, or residential applications, providing consistency and reliability.

Further, in an embodiment of the invention, the system maintains a constant set output frequency of the generator independent of the variable output HP and the variable output RPMs. The consistency ensures stable and reliable power supply, essential for the smooth operation of sensitive electronic equipment that requires steady frequency to function correctly. It accommodates fluctuating power demands and engine speeds without compromising power quality, enhancing the system's flexibility and efficiency, and reducing the risk of equipment malfunction or damage due to frequency variations. Additionally, the processor determines the load requirement of the load, and adjusts speed of the generator to produce the load requirements for the load. The processor adjusts the generator speed enhances fuel efficiency and reduces wear and tear. By matching the generator's output precisely with the demand, the processor ensures optimal energy production, minimizing unnecessary energy wastage and prolonging the lifespan of the generator. Such a speed control mechanism provides improved operational efficiency, cost savings on fuel, and a lower environmental impact due to reduced emissions.

The receiving element operates in conjunction with the processor, for gathering data on the load's current demands and relaying this information to the processor for aligning generator's output with the requirements of the connected load or equipment. The receiving element, in one example, can be a sensor or a set of sensors combined with advanced communication interfaces that gather and relay data about the current demand or load on the system. In another example, the receiving element is a load sensor, for measuring the electrical load directly by monitoring parameters such as current, voltage, and power factor for the load 110. The sensors of the receiving element provide real-time data, enabling the power generation system to adjust its output dynamically to match the load requirements, thus optimizing efficiency and preventing overloading or underloading scenarios.

The controller 116 connected to the processor in the system plays a pivotal role in regulating various operational parameters. It acts as the intermediary that interprets the processor's commands and adjusts the system's functioning accordingly. This setup allows for precise control over multiple aspects, such as speed, power output, and efficiency, ensuring the system operates within optimal parameters. The controller's ability to adjust these factors in real-time, based on feedback from the processor, enables the system to respond dynamically to changing load demands or operational conditions, enhancing the overall performance, reliability, and flexibility of the system

The user interface 117 of the system allows users to select between AC or DC outputs, different voltage values, opt for single or three-phase power, and even adjust frequency settings. This level of control is facilitated through sophisticated software, eliminating the need for manual reconfiguration of the generator's hardware. Current single-phase systems are designed with generators that have four leads, allowing connection for either 120 or 120/240 volts. A 3-phase generator typically will have 12-24 leads, offering various connection options to meet specific voltage needs. Although you can configure a 3-phase generator for single-phase power but, it reduces the generator's output by about 35%.

The disclosed system includes a neutral stud and three output Lines for AC output, enabling easy selection between single or dual voltage and single-phase or three-phase power. This simplifies voltage, phase selection, and system monitoring through integrated software, and there is no loss in output power from 3-phase to single phase

Additionally, the system's connectivity elements leverage a CAN-Bus architecture, like N2K, to enable seamless data transmission to external systems or devices. This feature not only enhances the system's interoperability but also simplifies monitoring and integration with broader energy or management systems. The N2K provides the ability to connect directly to other systems without having to go thru a conversion or other complicated connection protocols. There are multiple options for connectivity. In one example, the data associated with the system may be configured to be displayed on a single panel on the generator, or the data can be sent to a second panel connected to an external system. In another example, the data can also be entered into a different system through the CAN-Bus connection in order to link to an existing system.

Further, the variable speed generator system has a specific arrangement and selection of magnets within the rotor assembly and coils within the stator assembly, tailored to optimize the electromagnetic interaction for a predefined generator size and output capacity, including but not limited to 20 kW of output at 124/240 volts for both single and three-phase applications. The variable speed generator system has an electronics and software configuration designed to adjust the pulse width modulation (PWM) signal to maintain output voltage at desired levels despite fluctuations in load.

As noted above, the system is designed to produce the selected voltage output at the idle speed as well as having its “Voltage Buffer”. The generator output remains within optimal operational parameters by utilizing insulated-gate bipolar transistors (IGBTs) for rapid modulation of electrical output. In the electronics package, the processor is equipped with the electronics package including a core processor. In an example embodiment, the core processor is an Atmel ATmega 2560, supporting multiple PWM channels and programmable I/O channels, with the ability to output different voltages simultaneously through independent channels and capable of adjusting engine speed based on real-time load requirements. For example, the core processor has the ability to have multiple PWM channels up to 16 Bits, and up to 86 programable I/O channels with an internal clock speed of 16 MHz. The program creates a PWM signal that is calculated by creating a lookup table. This table is based on periods of time during which the user selects frequency combined with a selected number of channels/sine divisions. The following formula is used for this calculation: (period=microMHz*1e6/freq/SinDivisions). The number of channels in the complete sine wave is divided by 2 to account for the positive and negative portions of the sine wave. Two output signals emanate from the processor corresponding to each line. There can be multiple lines coming out of the processor to give the option of multiple voltages at the same time. These 2 two signals emanate in two selected channels, Hi and Low. Each signal is subsequently directed into its respective channel. Each channel is comprised of two opto-couplers. These opto-couplers are responsible for transmitting the high and low signals to a high/low driver.

In another example embodiment, the electronics package further includes the Insulated-gate bipolar transistors (IGBT) module receiving High/low signals and DC voltage from the stator diode assembly for converting DC stator output into an AC sine wave output at the requested frequency, independent of generator RPMs. For example, each module manages extremely high voltages and currents, reaching thousands of amperes. Further, as noted above, the generator output remains within optimal operational parameters by utilizing the insulated-gate bipolar transistors (IGBTs) for rapid modulation of electrical output. The modules can also quickly switch on and off more than 10,000 times every second. This rapid switching is part of creating the AC sine wave, for converting the DC output from the stator into an AC sine wave output, set at the desired frequency of 60 Hz. This process allows the electronics to determine the frequency of the output independently from the engine's speed. These modules will be separate from the main PCB and mounted to their own heatsink.

The electronics package is designed to manage voltage output, engine control, and monitoring, while also providing seamless connectivity to other existing systems. Adopting this comprehensive “total system” methodology enables the creation of an electric power generator that is markedly more versatile than the conventional generators presently available. This innovative system offers numerous benefits over traditional models, primarily through its enhanced efficiency, which surpasses that of existing systems. Additionally, the electronics package features a simplified power connection framework, that effectively minimizes the likelihood of operational errors. The system is further enhanced with components engineered to facilitate the transmission of information to external peripheral devices. The disclosed system is more compact compared to conventional alternatives, around 65% smaller than its counterparts, embodying a significant advancement in generator technology efficiency and design compactness.

The system is designed to produce fewer emissions, thereby significantly reducing its carbon footprint compared to conventional generators. This innovative approach is rooted in a “Power-by-Demand” philosophy, prioritizing the reduction of emissions and minimizing engine wear. The underlying principle of this design is to adapt the power output to the actual demand, unlike traditional generators that operate at a constant frequency regardless of the load. Traditional generators, by maintaining a steady speed irrespective of the energy requirement, often result in considerable fuel wastage. This not only leads to unnecessary fuel consumption but also accelerates engine wear due to the constant high operational tempo. Additionally, operating these conventional units without regard to the fluctuating power needs leads to the emission of substantial amounts of exhaust gases into the atmosphere, contributing to environmental pollution and increasing the generator's overall carbon footprint. In contrast, the “Power-by-Demand” system dynamically adjusts its output, ensuring that it only produces the amount of energy needed at any given time, thereby enhancing fuel efficiency, reducing wear on the engine, and significantly cutting down on the emission of harmful pollutants.

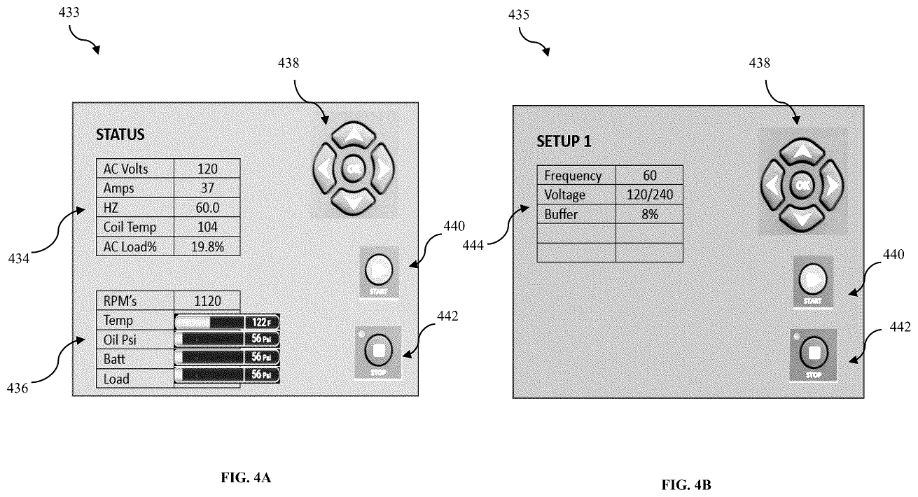

FIGS. 4A and 4B illustrate example graphical user interfaces (GUIs) 433 and 435, respectively, displayed on a computing device designed to monitor and control the system. In general, graphical user interfaces serve as interactive platforms enabling users to visualize and manipulate system data through graphical icons and visual indicators. As shown, GUI 433 presents status-related information 434 in a tabular format, offering a clear and immediate overview of critical operational metrics such as AC voltage, current (measured in amps), frequency (HZ), coil temperature, and AC load percentage. It also conveys other data 436 including real-time rotational speed (RPMs), the temperature of the associated machinery, oil pressure, battery status, and overall system load, displayed in both numerical and graphical formats. The numerical values offer precise measurements, whereas the graphical bars provide a quick visual reference, aiding the users in monitoring the health and performance of the system with efficiency and ease. In an example, the user interface provides a neutral stud and three output lines for AC output, simplifying voltage, phase selection, and system monitoring through integrated software.

The GUI 433 enhances interactivity through graphical navigating buttons 438, allowing users to intuitively navigate through different system views using arrow buttons. It also includes start and stop buttons 440 and 442, which facilitate the commencement and cessation of data collection and processing for status information display. The implementation of these buttons into the GUI simplifies the operational process, allowing users to initiate or halt the system's data monitoring and analysis with a single touch. This functionality ensures that users can efficiently control the timing and extent of system monitoring, which is particularly useful in scenarios requiring immediate response to changing system conditions.

Moreover, the GUI 435 displays additional setup-related information 444, including system frequency, voltage parameters, and buffer capacity. Using the navigating buttons 438, users can seamlessly transition between different user interfaces, including GUI 433 and 435, to access various sets of information. This ease of navigation between interfaces enables a more streamlined user experience. The advantage of such a system is presenting essential data in an accessible and organized manner, thereby improving the efficiency of system setup and status monitoring. The present invention, as represented by FIGS. 4A and 4B, showcases selective views of a comprehensive graphical user interface system designed for monitoring and controlling a variety of operational parameters in the system. While the figures exemplify specific embodiments of the user interface, it is to be understood that the invention encompasses a multitude of user interfaces and graphical buttons, for different functionalities and system requirements, covered in various embodiments. As noted above, the user interface provides a neutral stud and three output lines for AC output, simplifying voltage, phase selection, and system monitoring through integrated software.

The software used in monitoring and controlling operation of the components processes data collected from the system's components to provide real-time monitoring and management capabilities. The software operates across multiple interfaces, each dedicated to a particular aspect of the system's performance. For instance, a set-up screen and a service screen interfaces offer user input fields for essential parameters such as frequency (Hz), which can be set between 50 and 60, and the system phase, which can be toggled between 1 or 3. These screens also allow for the adjustment of voltage settings, tailoring the system's operation to the specific needs of the service or setup being performed. The software's dynamic architecture is designed to accommodate a variety of operational states and conditions, processing the inputted parameters to optimize system performance.

While the system is running, particularly in an idle state of the engine, the software anticipates and compensates for fluctuations in load with the use of its “Voltage Buffer”. The extra power stored in the buffer is utilized to instantaneously correct the output, maintaining a stable and consistent set voltage. This feature exemplifies the software's advanced design, which proactively manages the system's power delivery, ensuring that the output remains at the user-defined level despite the inherent variability in operational conditions. Such intelligent management of power and performance parameters significantly enhances the system's reliability and efficiency, representing a substantial improvement over conventional systems where manual adjustments are often required to maintain stable output levels.

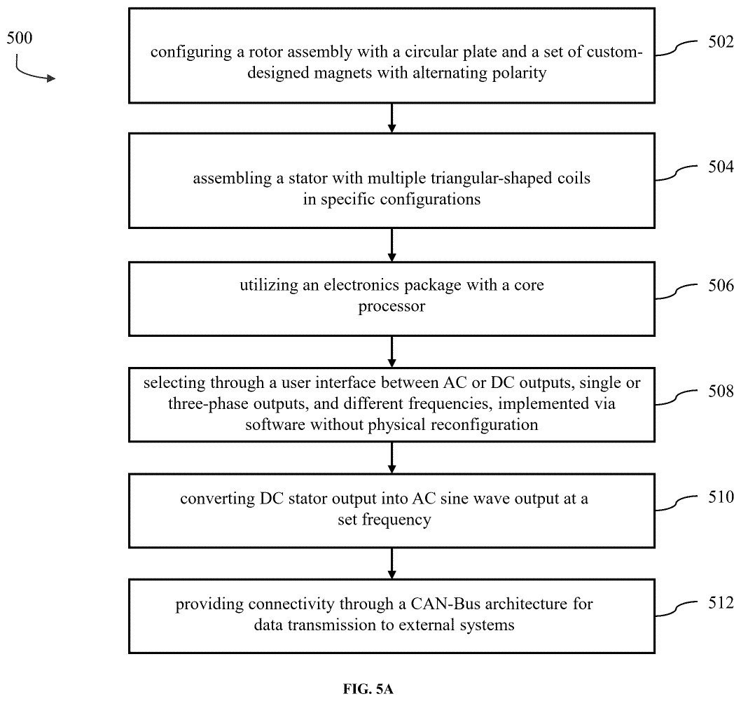

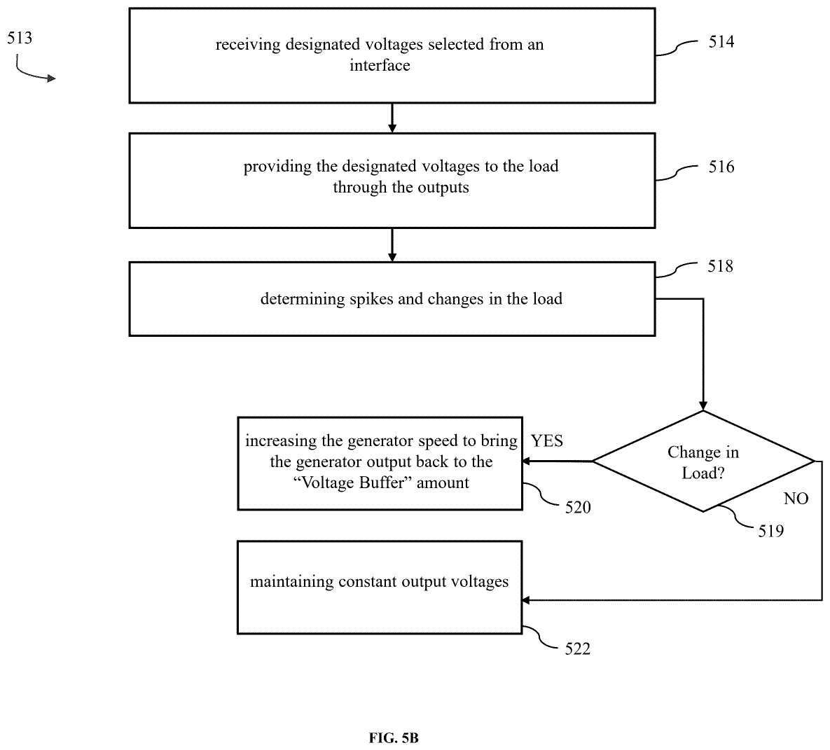

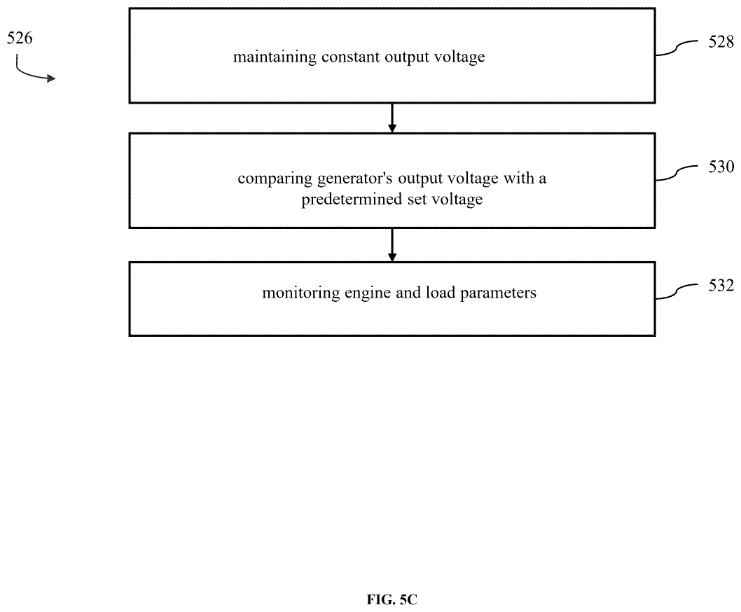

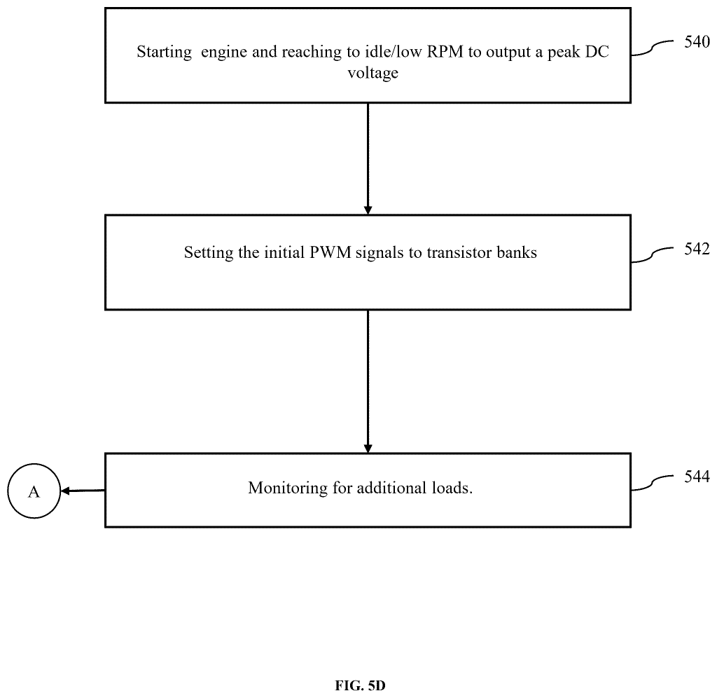

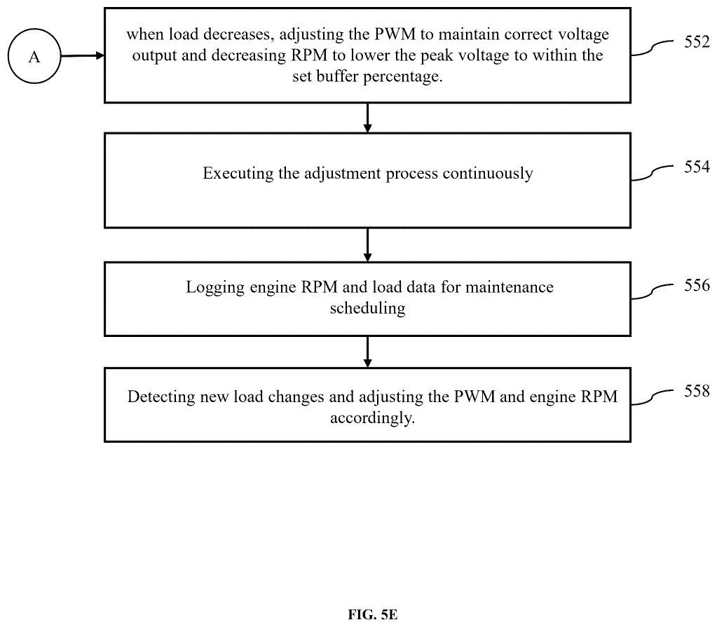

FIG. 5A is a flowchart depicting a method 500 for converting DC stator output into AC sine wave output at a set frequency. The step 502 involves configuring a rotor assembly, which includes the installation of a circular plate coupled with a set of custom-designed magnets exhibiting alternating polarity. The precise arrangement of the custom-designed magnets ensures optimal interaction with the stator's coils, which is essential for the effective generation of electromagnetic forces. This step sets the subsequent assembly of the stator, ensuring that the rotor's design is compatible with the forthcoming components and their functional requirements. Following the rotor assembly, step 504 encompasses the assembly of a stator, which is integrated with multiple triangular-shaped coils arranged in specific configurations. This design is pivotal for inducing electromagnetic forces when interacting with the magnetic field generated by the rotor. The step 506 includes incorporating an electronics package equipped with a core processor. In an example, the core processor is an Atmel ATmega 2560, supporting multiple PWM channels and programmable I/O channels. This inclusion is vital for managing and controlling the system's operations, including the monitoring of energy conversion processes and the regulation of output parameters. The core processor, such as the Atmel ATmega 2560, acts as the central unit that orchestrates the system's functionality, interfacing with both the mechanical and electrical components to ensure cohesive operation. This step is crucial as it bridges the mechanical energy conversion with the electronic control and customization capabilities, setting the groundwork for user-defined output specifications. In step 508, the system introduces an interactive user interface, enabling the selection between AC or DC outputs, the choice between single or three-phase outputs, and the adjustment of output frequencies. This flexibility is achieved through sophisticated software algorithms that allow for these variations without the need for physical reconfiguration of the system. As a result, the system maintains optimal efficiency and adaptability while eliminating the complexities and downtime associated with manual adjustments in physical reconfiguration. This feature empowers users to tailor the system's output to meet specific requirements, enhancing the adaptability and utility of the system. The seamless transition from the core processing unit's control to customizable user settings exemplifies the system's design for versatility and user-centric operation.

In step 510, the method includes conversion of DC stator output into AC sine wave output at a predetermined frequency. This conversion is critical for applications requiring AC power, where the sine wave output ensures compatibility with a wide range of devices and systems. The precise control over the output frequency allows the system to cater to various operational requirements, ensuring broad applicability. This step signifies the culmination of the system's internal processes and prepares the system for the final stage of external data transmission. The method described herein is performed by the system designed to provide connectivity through a CAN-Bus architecture for efficient data transmission to external systems. In step 512, the method includes providing connectivity through a CAN-Bus architecture, facilitating the transmission of operational data to external systems. This step is integral for real-time monitoring and control, enabling external devices or networks to access data regarding the system's performance, operational status, and output characteristics. The CAN-Bus architecture is reliable and efficient in automotive and industrial environments, and provides robust data communication. The method's advantage lies in its comprehensive approach to integrating a series of technically sophisticated steps into a seamless operational flow. This integration not only ensures high efficiency and adaptability in energy conversion and output customization but also facilitates advanced connectivity for external monitoring and control. The systematic progression from mechanical configurations through to electronic customization and communication ensures a high degree of precision, flexibility, and reliability, catering to a wide array of application requirements and enhancing the system's overall performance and utility.

FIG. 5B is a flowchart depicting the process for sensing a current draw and instructing the engine to raise its rpms to “refill” the “Voltage Buffer”. The “Voltage Buffer” ensures that the system can accommodate sudden increases in demand, maintaining reliability and preventing overloads.

In step 514, the method includes receiving designated voltages selected from an interface, for example, the user interface 310 of FIG. 3. In step 516, the method includes providing the designated voltages to the load through the outputs. After providing designated voltages to the load, the method in step 518 includes determining spikes and changes in the load. In an example, the system may determine the spikes and the changes by monitoring load conditions or changes in load to identify sudden increases in power demand. In an example embodiment, the system, in addition to monitoring current load conditions, may analyze historical data, if available, to identify the maximum expected load spikes. This involves reviewing past instances where the demand significantly exceeded the average load, considering factors that may cause such spikes, which could be operational changes, seasonal variations, or specific events that drive up power demand.

In step 519, the method includes determining a change in load. If there is a change in the load, the method proceeds to step 520. In step 520, the method includes increasing the generator speed to bring the generator output back to the “Voltage Buffer” amount when there is a change in load. When the voltage drops below this “Voltage Buffer” threshold due to increased load or other factors, accelerating the generator's speed compensates for the loss, thereby restoring the output voltage to the desired “Voltage Buffer”. This mechanism not only ensures a stable power supply but also enhances the reliability and efficiency of the electrical system, maintaining consistent voltage regardless of fluctuations in demand or other external conditions. In step 522, the method includes maintaining constant output voltage when there is no change in the load.

FIG. 5C illustrates a flow chart for a method 526 for adjusting generator speed, according to another example embodiment of the invention. In step 528, the method includes maintaining a constant output Voltage. This is achieved by implementing a feedback loop that continuously compares the generator's output Voltage with a predetermined set voltage value in step 530. The system employs various sensors and control algorithms to monitor the generator's output and make fine adjustments to the operational parameters. This constant monitoring ensures that any fluctuations in voltage are promptly corrected, thereby stabilizing the output. This step is foundational for the method as it establishes the baseline for the generator's performance, which is essential for the following monitoring activities. In the next step 532, the system focuses on monitoring engine and load parameters. This involves collecting data on the engine's operational state, such as RPM, temperature, and fuel consumption, along with the current load's power requirement. Advanced sensor technology and data acquisition systems play a critical role in this stage, ensuring accurate and real-time monitoring. The integrity of this step is paramount as it provides the necessary information for determining the system's load requirements, enabling the generator to respond to changing conditions efficiently.

In an example, a 4 pole 21 KW Onan generator that operates at 1800 rpms is used to maintain 60 hz. Traditionally generators use a voltage regulator to control the outputted voltage. This generator is set up to be at 61-62 Hz and 120-125 volts at no load. There is a DC voltage of about 4 volts introduced into the excitor stator. When a load is introduced and current is demanded from the output, the voltage drops a little and the generator bogs down a little, at that point the voltage regulator increases the DC voltage to the excitor stator to bring the voltage back to 120 volts. They use much larger engines to have enough power so that the load on the engine is minimum. The disclosed embodiment uses a 2.4-liter 4-cylinder diesel engine that makes 28 HP at 1800 rpms. If a smaller engine is used, the time that the engine needs to correct for the loss in rpm's becomes just one of its obstacles to overcome. With the disclosed system, the same KW output is achieved with a 1.1-liter motor of the same platform from the same manufacture. Due to the “Voltage Buffer” there is no bogging down on the engine, no loss in voltage, and no change in frequency.

In the disclosed embodiments, the variable speed aspect is based on selection of custom-designed magnets, the coils, the placement and configuration of the custom-designed magnets and the coils, and the electronics, software interacting with each other. The system is highly scalable, and the data is based on a particular size, 20 kw of output, 124/240 volts both single and three phase and may be applied to generators of different sizes.

In an example embodiment, at an idle speed the generator produces “Voltage Buffer” above the output needed, as the load increases, the voltage drops. In this situation, the software adjusts the PWM signal to so the output remains at the desired voltage. IGBTs may be used to achieve the output voltage very quickly. At this point, the software monitors the load being introduced, upon detecting an increase or decrease. The functionality is to always maintain the designated “Voltage Buffer” above the designated output voltage. Increases in load is absorbed by the “Voltage Buffer” and then the processor increases the engine rpms to re-establish the designated “Voltage Buffer”. This corrective mechanism is systematically executed, repeating as necessary until the generator reaches its specified limits for maximum rpm, kilowatt (kW) output, and amperage.

Software and electronics that creates a constant frequency through a broad variable speed range. The software and electronics package produces the PWM signal for the AC and or DC square and sine waves not the engine rpm. This allows the engine to always be at necessitated power in rpm and not in a continuous rpm, yielding much more efficiency. This also allows the engine to reach its peak power and torque ratings at slightly higher rpm.

The integrated software and electronic components are engineered to deliver varying frequencies across distinct channels, thereby granting users the capability to operate AC motors at diversified speeds. This sophisticated system is adept at generating both single and three-phaseoutputs without necessitating any compromises, ensuring optimal flexibility and efficiency in its operational capacity

Another advantage of the disclosed system is that the integrated software and electronics allows for multiple outputted voltages simultaneously. Since this system has multiple outputted PWM channels with their own set drivers and IGBT's, the system provides output voltages different on each of the channels, and allows the outputs to be both AC and DC voltages.

The disclosed system utilizes an axial flux design and selected materials provides the generator with numerous advantages over traditional radial flux models. Radial flux generators typically incorporate iron core laminated plates aligned with the coil's length, which can contribute to over 50% of the generator's backend weight, encompassing both stationary and rotating components. In contrast, the disclosed system uses 20kW generator having entire backend weighing well under 100 pounds, significantly lighter by more than 300 pounds compared to a conventional model used for benchmarking. Moreover, the importance of rotating weight is highlighted, with the disclosed generator's rotating assembly weighing under 60 pounds. This is in stark contrast to the heavier rotors of competitive units, which can weigh around 200 pounds, it takes a bit more energy to spin the extra weight of the traditional rotor. The disclosed design efficiently concentrates magnetic force, reducing its spread to less than 20% across a length of under 4 inches, unlike the broader 70% distribution over 18 inches in traditional designs. The disclosed system has a 70% reduction in rotating mass, contributing to efficiency improvements and the potential for utilizing a smaller, more efficient engine. This significant reduction in weight is one of the many factors contributing to the expected efficiency gains and a less cumbersome, more energy-efficient engine of the disclosed system.

As noted above, the system's efficiency is significantly higher, allowing for a new generator model that features an engine half the size of those from current manufacturers, and an electrical back-end that is also less than half the size. In terms of rotating mass, the total weight of our rotor and magnet array is 60 pounds, compared to around 200 pounds for a similar unit from other conventional models.

The disclosed systems are significantly more compact, being less than half the size and weight compared to conventional units. They are engineered to efficiently operate at variable speeds, maintaining 70-80% load capacity at the given RPM, with the capability to automatically increase the engine speed when the load exceeds 75%. This adjustment allows the engine to scale the output power as needed, up to its maximum capacity. Such a design is not only more efficient but also minimizes stress on the engine, resulting in reduced maintenance needs and less carbon accumulation. This approach ensures that the engine optimally adjusts to varying load requirements, enhancing overall performance and longevity. As the kilowatt output gets larger the footprint compared to traditional systems becomes even smaller and lighter.

FIGS. 5D and 5E are flowcharts of a method for operating the system, according to an example embodiment. The flowcharts presented as FIGS. 5D and 5E illustrate an embodiment of a generator control system, tailored to a specific configuration with the following parameters. The system is designed to operate at 60 Hz and outputs 120/240 Volts AC in a single-phase setup, using two output transistor banks. The AC voltage values mentioned are in RMS (root mean squared), which involves converting from peak voltage using a factor of 0.707. Consequently, a 120 volts RMS output correlates to approximately 169.73 volts peak. The DC voltage, initially outputted from the stator and processed through a rectifier, is measured in peak values. After conversion by the MOSFET transistor pairs, this is transformed into AC voltage but measured in RMS, not peak. The system includes a buffer, estimated at about 8%, which facilitates voltage regulation and allows for rapid adjustments through software without the need for mechanical changes in engine speed. This flowchart effectively encapsulates the operational workflow and adjustment mechanisms that enable the system to maintain voltage stability and efficiency under varying load conditions.

The control system of the generator is designed to efficiently manage its operation through a series of steps, starting from the initiation of the engine to the continuous monitoring and adjustment of its functions. This process is depicted in a flowchart, labeled as FIGS. 5D and 5E and is described below in detailed steps. In the step 540, the engine is started that involves starting up the engine and stabilizing at an idle or low RPM. This buffer is crucial as it allows for instant voltage adjustment through software, which is quicker and less complicated than mechanical adjustments. In the next step 542, an initial voltage is set. The software sets the initial PWM (Pulse Width Modulation) signals to transistor banks depending upon the output is may be, 120V, 120-140. The system may have different configuration having different number of transistor banks. For instance, it may have one bank, two banks or three banks. In one example, there may be two transistor banks A and B. This step ensures that the transistor bank A produces a 120 volts AC sinewave at 60 Hz, while transistor bank B outputs a phase-shifted wave to collectively achieve a desired 240 volts. This setup is designed to optimize the electrical output while maintaining efficiency and reducing the mechanical strain on the generator. In step 544, the method includes monitoring the load for any decrease or increase.

In cases where the load decreases, in the step 552 of FIG. 5E, adjustments are made for decreased load. This involves reducing the PWM output and engine RPM to bring the system back within its voltage buffer range. This adaptive response helps maintain efficiency and prolongs the generator's operational integrity. In the subsequent step 554, the cycle of monitoring increase or decrease of the load and adjusting the PWM output and engine RPM is continuously adjusted by the software. The software also logs data as shown in the step 556. The process is repetitive where the system parameters are repeatedly monitored and adjusted as shown in the step 558. This ensures that the generator is always running at optimal levels, adapting to new conditions, and logging vital operational data for maintenance and operational analysis. This structured approach allows the generator to function effectively under varying loads without the high RPM typically required by traditional systems, thus saving fuel, reducing wear and tear, and minimizing emissions.

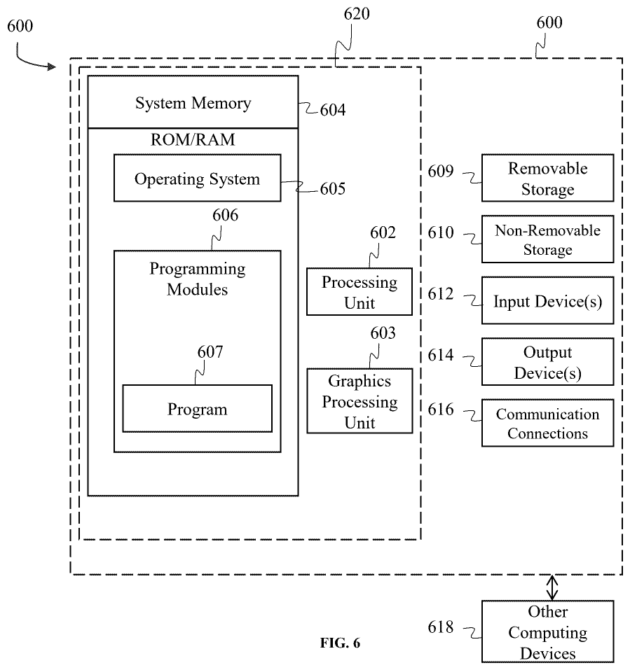

FIG. 6 is a block diagram of a system including an example computing device 600 and other computing devices. Consistent with the embodiments described herein, the aforementioned actions performed by the system 100, the user device 114, or the external system 120 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Further-more, computing device 600 may comprise an operating environment for the methods shown in FIGS. 1 through 5 above.

With reference to FIG. 6, a system consistent with an embodiment of the invention may include a plurality of computing devices, such as computing device 600. In a basic configuration, computing device 600 may include at least one processor and a system memory 604. Depending on the configuration and type of computing device, system memory 604 may comprise, but is not limited to, volatile (e.g., random access memory (RAM)), nonvolatile (e.g., read-only memory (ROM)), flash memory, or any combination or memory. System memory 604 may include operating system 605, one or more programming modules 606 (such as program module 607). Operating system 605, for example, may be suitable for controlling computing device 600's operation. In one embodiment, programming modules 606 may include, for example, a program module 607. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable, and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acous-tic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 may perform processes including, for example, one or more of the methods shown in FIGS. 5A through 5C above. Computing device 600 may also include a graphics processing unit 603, which supplements the processing capabilities of processing unit 602 and which may execute programming modules 606, including all or a portion of those processes and methods shown in FIGS. 5A through 5C above. The aforementioned processes are examples, and processing unit 602 may perform other processes. Other program-ming modules that may be used in accordance with embodi-ments of the present invention may include electronic mail and contacts applications, word processing applications, spreadsheet applications, database applications, slide presentation applications, drawing or computer aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configura-tions, including handheld devices, multiprocessor systems, microprocessor based or programmable consumer electronics, minicomputers, mainframe computers, and the like. Embodiments of the invention may also be practiced in distributed computing environments where tasks are performed by remote processing devices that are linked through a communications network.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the function-ality/acts involved.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The subject matter disclosed in the appendices attached hereto is hereby incorporated by reference as if fully set forth herein. All technical details, diagrams, descriptions, and claims contained within the appendices shall be considered an integral part of this patent application. The appendices are intended to provide additional support and clarification for the claims and embodiments described in this application. Any reference to the appendices within this document shall be interpreted as incorporating the complete contents of the appendices, ensuring their full inclusion and applicability to the subject matter of this patent application.

1. A system for generating power using a variable speed generator, the system comprising:
an engine;
wherein the engine is configured to operate within a range of a plurality of engine outputs;
wherein each of the engine outputs comprises a variable output revolutions per minute (“RPM”);
an axial flux oriented generator connected to the engine, the axial flux oriented generator comprising:
a rotor assembly with a circular plate comprising a plurality of magnets, wherein the plurality of magnets are configured with alternating north and south poles; and
a stator assembly comprised of a plurality triangular-shaped coils connected to achieve desired output voltages and power levels, and output terminals from the plurality triangular-shaped coils are connected to a rectifier to convert AC signal into DC power;
a receiving element in communication with a processor for receiving load requirements of the load electrically connected to the variable speed generator system;
a user interface allowing for selection between AC or DC voltage outputs, single or three-phase outputs, and different frequencies, all selections programmable via software without a need for physical reconfiguration of the axial flux oriented generator;
a plurality of connectivity elements for data transmission to external systems or devices via a CAN-Bus architecture (e.g., N2K), facilitating system integration and monitoring;
wherein the processor comprises instructions configured for:
maintaining a constant set output frequency of the axial flux oriented generator independent of a variable output RPMs;
determining a load requirement of the load electrically connected to the axial flux oriented generator; and
adjusting a speed of the axial flux oriented generator to produce the load requirements for the load while maintaining the constant set output frequency; and
wherein the processor is configured to produce a plurality of output channels, each output channel configured to provide one of a multiple of output voltages (single-phase or three-phase, AC and/or DC), including an operational “Voltage Buffer” to accommodate load spikes;
wherein the processor is configured such that each output channel comprises an operational “Voltage Buffer” over a required output voltage to handle any load spikes in the load requirements.

2. The system of claim 1 further comprising:
a specific arrangement and selection of magnets within the rotor assembly and coils within the stator assembly, tailored to optimize electromagnetic interaction for a predefined generator size and output capacity, including but not limited to 20 kW of output at 120/240 volts for both single and three-phase applications; and
an electronics and software configuration designed to adjust a pulse width modulation (PWM) signal to maintain output voltage at desired levels despite fluctuations in load, wherein the system is engineered to produce an initial voltage output exceeding a required operational voltage by a predefined “Voltage Buffer” to accommodate increased loads without significant voltage drop;
wherein an electronics and software are further configured to dynamically adjust revolutions per minute (RPM) of the engine based on real-time monitoring of output voltage and load requirements of the axial flux oriented generator, ensuring generator output remains within optimal operational parameters by utilizing insulated-gate bipolar transistors (IGBTs) for rapid modulation of electrical output.

3. The system of claim 1, wherein the rotor assembly comprises a circular plate attached to the plurality of magnets on a first side of the circular plate and a second plurality of magnets on a second side of the circular plate to double a kilowatt (KW) output with minimal increase in length.

4. The system of claim 1, wherein the stator assembly is modular, allowing assembly in one, two, or three sections depending on a desired output, and includes output terminals connected to a rectifier for converting AC signal into DC power.

5. The system of claim 1 further comprising an electronics package;
wherein the processor is equipped with the electronics package including a core processor;
wherein the core processor supports multiple PWM channels and programmable I/O channels, with an ability to output different voltages simultaneously through independent channels and capable of adjusting engine speed based on real-time load requirements.

6. The system of claim 5, wherein the electronics package further comprises an IGBT module receiving PWM signals and DC voltage from a stator diode assembly for converting DC stator output into an AC sine wave output at a requested frequency, independent of generator RPMs.

7. The system of claim 1, wherein the user interface provides a neutral stud and three output lines for AC output, simplifying voltage, phase selection, and system monitoring through integrated software.

8. A method for generating electrical power in a generator system, the method comprising:
configuring a rotor assembly with a circular plate and a set of custom-designed magnets with alternating polarity;
assembling a stator with multiple triangular-shaped coils in specific configurations to produce desired output voltages and power levels;
utilizing an electronics package with a core processor to generate PWM signals based on a calculated lookup table for desired frequency and sine divisions;
selecting through a user interface between AC or DC outputs, single or three-phase outputs, and different frequencies, implemented via software without physical reconfiguration;
converting DC stator output into AC sine wave output at a set frequency using an IGBT module, independent of generator RPMs; and
providing connectivity through a CAN-Bus architecture for data transmission to external systems or devices, enhancing system integration and monitoring.
